(19) United States
(12) Patent Application Publication
(10) Pub. No.: US 2014/0223706 A1
(43) Pub. Date: Aug. 14, 2014

(54) INJECTED MOLDED CASKET

(71) Applicant: Joshua H. Abrams, Fort Lauderdale, FL (US)

(72) Inventor: Joshua H. Abrams, Fort Lauderdale, FL (US)

(21) Appl. No.: 14/167,690

(22) Filed: Jan. 29, 2014

Related U.S. Application Data
(60) Provisional application No. 61/763,320, filed on Feb. 11, 2013.
(60) Provisional application No. 61/831,512, filed on Jun. 5, 2013.

(51) Int. Cl. A61G 17/007

(52) U.S. Cl. CPC A61G 17/007
USPC 27/3; 27/7

(57) ABSTRACT

A casket comprising a tub and a lid formed of molded plastic and walls formed of honeycomb, cellular or foam structure sandwiched between an inner and outer plastic skins, or structural or rotational molded foam, or thermo molded foam, and including a valve for preventing pressure build up within the casket.

### CROSS REERENCE TO RELATED APPLICATIONS

This application claims priority from U.S. Provisional Application Ser. No. 61/763,320, filed Feb. 11, 2013, and U.S. Provisional Application No. 61/831,512, filed Jun. 5, 2013.

### BACKGROUND OF THE INVENTION

This invention relates generally to caskets, and more particularly, to injected molded caskets fabricated of plastic material.

Caskets fabricated of fiberglass or plastic in place of conventional caskets formed of wood and metal have been proposed in the prior art and are described, for example, in U.S. Pat. Nos. 2,579,756, 3,164,880, 5,680,682, 7,703,186, 7,730,595 and 8,291,556. Caskets fabricated of fiberglass or plastic have advantages over caskets formed of wood or metal in terms of weight. Also, unlike wood, caskets fabricated of fiberglass or plastic will not rot, and unlike metal will not corrode. Notwithstanding these advantages, caskets fabricated of fiberglass or plastic have not achieved consumer acceptance since they do not offer the look and feel of conventional wood or metal caskets, and do not have the compressive strength and rigidity of conventional wood or metal caskets.

### SUMMARY OF THE INVENTION

The present invention provides a casket made of injection molded plastic in which the tub walls and lids are formed of a honeycomb or other cellular or foam core sandwiched between inner and outer plastic skins. The honeycomb or other cellular or foam core is held between the inner and outer plastic skins. Alternatively, the tub walls and lids may be formed of a structural foam formed by structural foam molding, thermo molded foam, or rotational molded foam. Lifting handles optionally may be anchored to backing plates that are molded in situ in the core during manufacture of the tub. Also if desired, half hinge plates may be molded in situ in the tub and cover so that the cover may be rigidly attached to the tub. In a preferred embodiment, the tub and the cover are formed of recyclyed plastic, preferably high density polyethylene and/or polypropylene, or bio-based plastic(s).

### BRIEF DESCRIPTION OF THE DRAWINGS

Further features and advantages of the present invention will be seen from the following detailed description, taken in conjunction with the accompanying drawings, wherein,

FIG. 1 is a side elevational view showing a casket in accordance with the present invention;

FIG. 2 is a view similar to FIG. 1 showing the tub portion of the casket;

FIG. 3 is an end view, in partial cross-section, of the casket of FIG. 1.;

FIG. 4 is a perspective view showing details of the honeycomb core forming the walls of the casket, with one skin removed to better show the structure;

FIG. 5 is a perspective view showing a complete honeycomb core section used to form the walls of the casket;

FIG. 6 is a perspective view showing an alternative casket made in accordance with the present invention; and

FIG. 7A is a cross section and FIG. 7B a top plan view of a cellular foam core with inner and outer skins.

### DETAILED DESCRIPTION OF EMBODIMENTS OF THE INVENTION

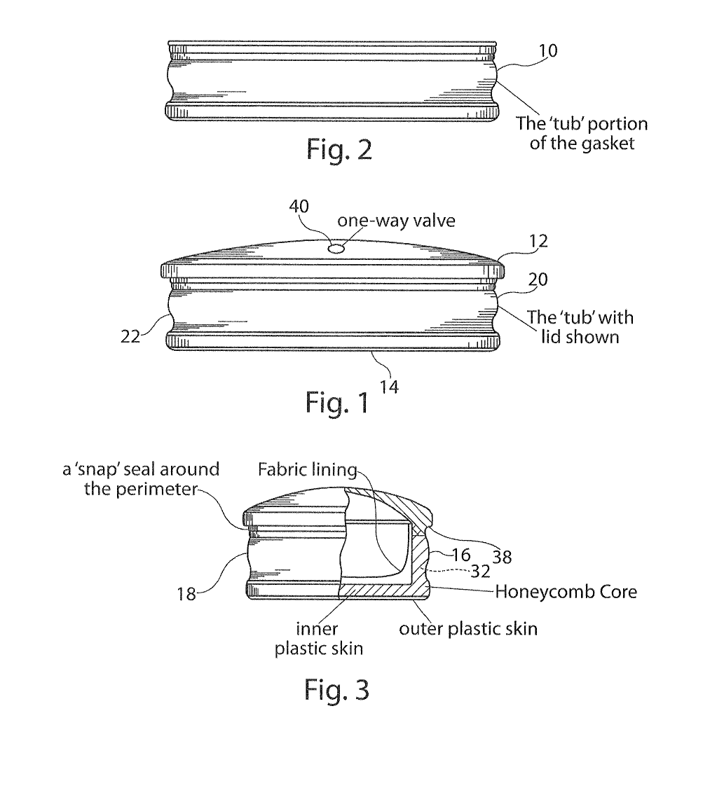

Referring to FIGS. 1-3, the basic casket includes a tub 10 with a lid 12. The tub includes a bottom 14, sidewalls 16, 18 and end walls 20, 22.

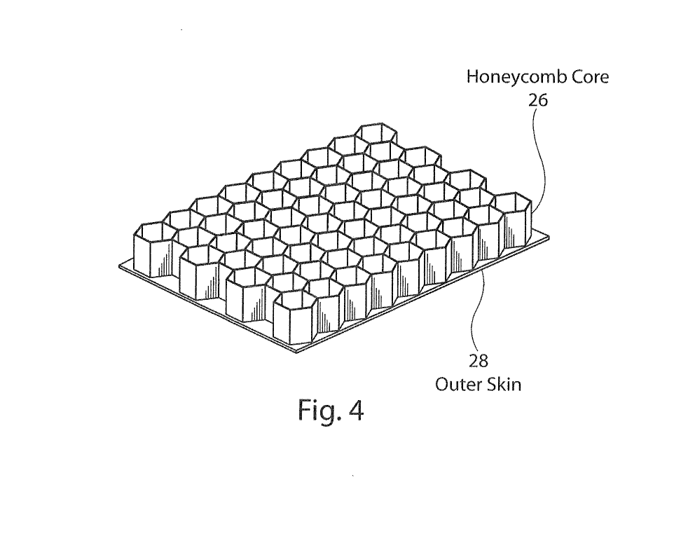

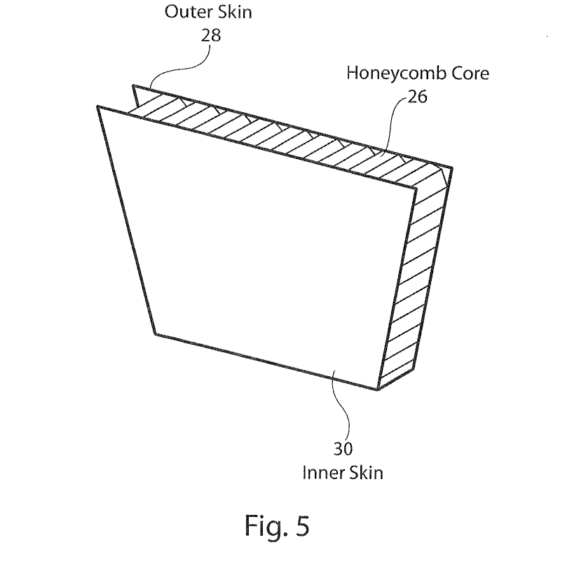

Tub 10 and lid 12 are made of injection molded plastic which will be described in detail below. Preferably the tub and lid are formed of recycled plastic such as high-density polyethylene and/or high-density polypropylene, or bio-based plastic. Referring also to FIGS. 4 and 5, the base and walls of tub 10 and top comprise a honeycomb or cellular or foam core 26 formed between plastic inner and outer skins 28, 30. Preferably the walls are formed by fixing an injection molded plastic honeycomb core 26 to a hard plastic shell 28. Alternatively, the honeycomb or cellular or foam core 26 may be formed in situ on skin 28 by lining one or both sides of the mold with sheet 28 prior to injection molding the honeycomb. The casket also may be manufactured using other plastic molding techniques including, but not limited to structural foam molding, rotational molding (roto-molding), and thermo molding. Structural and rotational molding create their own cores, while thermo molding creates a hollow core.

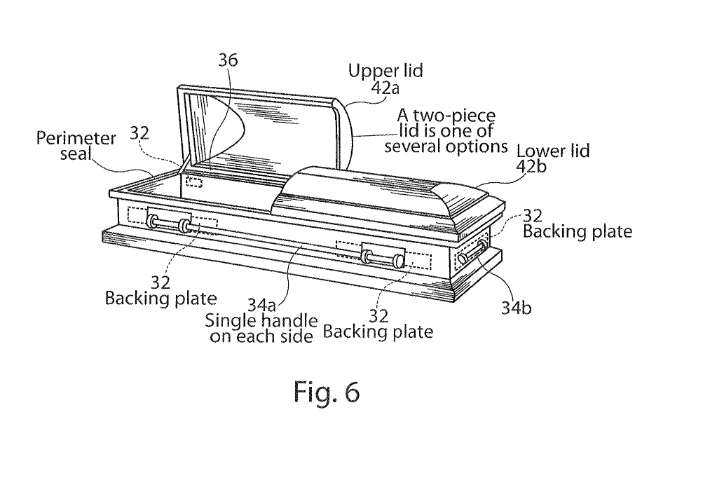

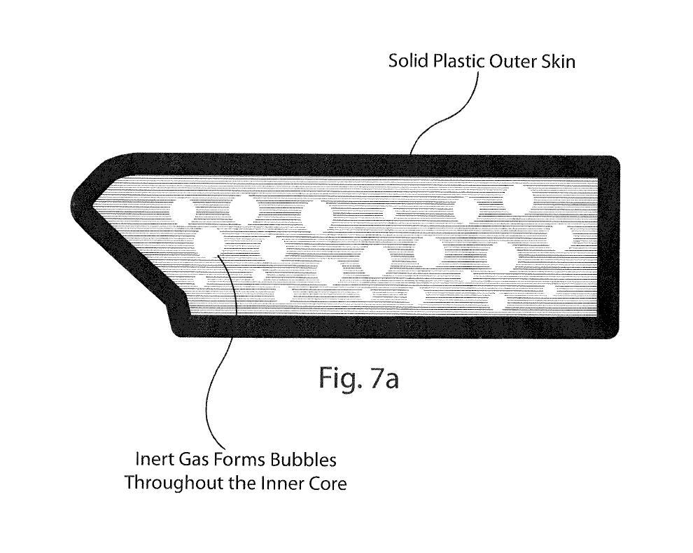

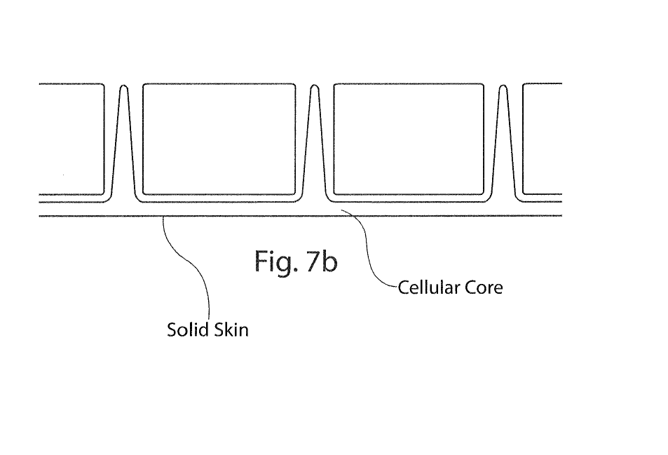

Referring also to FIG. 6, one or more backing plates 32 may be molded in situ in the core 26 for attaching handles 34a, 34b and hinges 36.

In a preferred embodiment, the tub 10 and top 12 are shaped to form a seal 38 around their mating perimeters. The lid then may be closed onto the tub for forming a water and air tight seal.

To prevent pressure build-up within the casket, a valve 40 preferably is fitted in the lid or tub allowing gases to escape.

The exterior of the casket may be “wrapped” in a decorative sheet vinyl or other material to resemble woodgrain, brushed metal, chrome, gold or any number of solid

Referring to FIGS. 1-3, the basic casket includes a tub 10 with a lid 12. The tub includes a bottom 14, sidewalls 16, 18 and end walls 20, 22.

Tub 10 and lid 12 are made of injection molded plastic which will be described in detail below. Preferably the tub and lid are formed of recycled plastic such as high-density polyethylene and/or high-density polypropylene, or bio-based plastic. Referring also to FIGS. 4 and 5, the base and walls of tub 10 and top comprise a honeycomb or cellular or foam core 26 formed between plastic inner and outer skins 28, 30. Preferably the walls are formed by fixing an injection molded plastic honeycomb core 26 to a hard plastic shell 28. Alternatively, the honeycomb or cellular or foam core 26 may be formed in situ on skin 28 by lining one or both sides of the mold with sheet 28 prior to injection molding the honeycomb. The casket also may be manufactured using other plastic molding techniques including, but not limited to structural foam molding, rotational molding (roto-molding), and thermo molding. Structural and rotational molding create their own cores, while thermo molding creates a hollow core.

Referring also to FIG. 6, one or more backing plates 32 may be molded in situ in the core 26 for attaching handles 34a, 34b and hinges 36.

In a preferred embodiment, the tub 10 and top 12 are shaped to form a seal 38 around their mating perimeters. The lid then may be closed onto the tub for forming a water and air tight seal.

To prevent pressure build-up within the casket, a valve 40 preferably is fitted in the lid or tub allowing gases to escape.

The exterior of the casket may be “wrapped” in a decorative sheet vinyl or other material to resemble woodgrain, brushed metal, chrome, gold or any number of solid colors and prints, including custom prints that might include for example, a representation of the deceased's hobby or profession. Further customization of the decorative exterior may include a photo or artistic representation of the deceased and or their family, their name, a prayer, or other personalization. The interior of the tub and lid may be covered in typical fashion using, for example, satin, crepe or other appropriate batting and fabric. The casket may be of any size to accommodate an adult, child, or a deceased pet.

The lid 12 may be formed of one-piece lid, i.e. as shown in FIG. 1, or a two-piece lid 42a, 42b to permit viewing. Preferably, the tub and the lid may be formed in a one-shot mold. Alternatively, the lid and/or tub may be formed by assembling several pieces of honeycomb core in a desired shape, and wrapping the shaped core in inner and outer sheets. The core may be formed from virtually any plastic material that may be injection molded including recycled plastic, and bio-based plastic. Thus, the present invention provides a casket which is strong and light weight and economically moldable. Yet, the casket is virtually indestructible and impervious to moisture and microbes, while sealing in body fluids. The provision of a valve permits out gassing so that integrity of the walls and seal is otherwise maintained.

Various changes may be made without departing from the spirit and scope of the present invention.

We claim:

1. A casket comprising a tub and a lid formed of molded plastic and walls formed of honeycomb, cellular or foam structure sandwiched between an inner and outer plastic skins, or structural or rotational molded foam, or thermo molded foam, and including a valve for preventing pressure build up within the casket.

2. The casket of claim 1, wherein the casket is formed at least in part of recycled plastic or bio-based plastic.

3. The casket of claim 1, further comprising one or more reinforcing elements in the tub walls to which handles and/or hinges may be affixed.

4. The casket of claim 1, wherein the lid and tub are fitted to form an air and water tight seal.

5. The casket of claim 1, further including a ring seal which extends continuously around mating perimeter surfaces of the tub and lid.
